(19) United States
(12) Patent Application Publication
(10) Pub. No.: US 2012/0130822 A1
(43) Pub. Date: May 24, 2012

(54) COMPUTING COST PER INTERACTION FOR INTERACTIVE ADVERTISING SESSIONS

(75) Inventors: Pritesh Patwa, Redmond, WA (US); Wook Jin Chung, Kirkland, WA (US); Martin Markov, Bellevue, WA (US)

(73) Assignee: Microsoft Corporation, Redmond, WA (US)

(21) Appl. No.: 12/949,813

(22) Filed: Nov. 19, 2010

(51) Int. Cl. G06Q 30/00

(52) U.S. Cl. 705/14.69

(57) ABSTRACT

Described herein are technologies related to charging advertisers for advertisements presented to a user in an interactive advertising session. An advanced interactive system captures gestures, spoken words, facial expressions, and the like, and advertisements are presented to a user based upon such captured gestures, spoken words, facial expressions and the like. User interactions with respect to these advertisements are then captured, and advertisers are charged fees per captured interactions between the user and the advertisements.

### BACKGROUND

Currently, search engines allow users to search over a significant amount of information by providing the search engine with a query, wherein the query includes a plurality of keywords. The search engine is configured to parse such query and utilize a variety of algorithms to return relevant results to the user. Search engines generate a significant amount of revenue by selling advertising space to advertisers, wherein advertisements that are shown together with search results. Typically, an advertiser will wish to advertise to consumers that have shown some interest in a product or service offered by the advertiser, and thus advertisers choose to advertise based upon keywords in queries proffered by users. Thus, for instance, if the user performs a search for “breakfast blend coffee,” then a coffee house or café may wish to advertise their products or services to the user. That is, the advertiser can infer that since the user is performing a search for coffee, the user may be interested in purchasing coffee.

Conventionally, in connection with purchasing advertising space, advertisers place bids on certain keywords entered by users. The search engine then sells advertisement space to advertisers that bid on the keywords. In most advertisement rendering systems, the search engine charges a fee to the advertiser when a user utilizes a mouse to click an advertisement displayed to the user. Furthermore, in some advertisement rendering systems, advertisements in a particular advertising space will change after a threshold amount of time has passed. That is, the search engine sells the advertiser advertisement space for some predetermined threshold amount of time, and then such advertisement space can be subsequently sold to another advertiser after the passage of the threshold amount of time. Thus, in summary, in current advertisement rendering systems, advertisements are primarily driven by keywords in a deterministic fashion, and an amount of time that an advertisement is shown is based on time thresholds.

These conventional advertisement rendering systems have been crafted for current human-machine interfaces. More specifically, users of a search engine direct an Internet browser to a web page of the search engine through utilization of a mouse or keyboard, and thereafter utilize a mouse to select a text entry field, and subsequently utilize the keyboard to provide a query to the search engine. The search results are then provided to the user, and advertisements for products or services related to the query are shown together with the search results. These types of advertisement rendering systems, however, may become obsolete in view of ever-advancing human-machine interface technologies.

### SUMMARY

The following is a brief summary of subject matter that is described in greater detail herein. This summary is not intended to be limiting as to the scope of the claims.

Described herein are various technologies pertaining to presenting a user with an interactive advertising session, and more particularly to charging advertisers for presenting advertisements to a user during an interactive advertising session. Recently, consumer-level technology has become readily available that allows users to interact with computing devices in intuitive manners, such as through speech or natural motion. Platforms that support this type of interaction can be referred to herein as advanced interactive platforms. In an example, a sensor unit can be in communication with a computing device, wherein the sensor unit can include a video camera, a microphone, a depth sensor, amongst other sensors. A computing device can be configured with motion sensing technology, gesture recognition technology, voice recognition technology, amongst other technologies such that gestures of a user can be recognized in real-time, voice commands of the user can be recognized in real time, emotions of the user can be inferred, etc. Given these advancing technologies, a manner in which individuals interact with computing devices will alter.

Aspects described herein pertain to presenting advertisements to a user in such an advanced interactive platform, and charging the advertisers for presenting such advertisements. In an example, a user employing a computing device that supports advanced interactive can indicate by voice that they are hungry. This indication can be captured by way of a microphone and analyzed to recognize the intent of the user. Subsequently, an advertisement can be presented to the user for a particular restaurant at a location that is proximate to the user. This advertisement may be presented in the form of an audible question such as “are you hungry for restaurant X?” It can be ascertained that “restaurant X” is an advertiser that wishes to inform the user of the availability of food at restaurant X. At this point, the user may shake her head in a manner that indicates that they are not interested in food at that particular restaurant. A camera can capture this gesture, and through gesture recognition technology the gesture can be automatically recognized. Accordingly, an advertisement for a different restaurant can be presented to the user. For instance, the advertisement may be in the form of an audible output that says “there are specials on sushi at restaurant Y.” The user may be interested in this restaurant and can ask “where is restaurant Y?” Responsive to this request from the user, a map can be presented to the user on a display screen of a computing device that provides a user with directions to restaurant Y from the current location of the user. Thus, it can be ascertained that an interactive advertising session comprises a plurality of advertisements that are presented to a user in a sequence, wherein an advertisement in the sequence is selected based at least in part upon a user interaction with a previous advertisement in the sequence.

In such an interactive advertising session, there are a plurality of different factors that can be taken into consideration when charging an advertiser for presenting an advertisement to the user. These factors can include an amount of time required to present the advertisement to the user, intensity of the advertisement presented to the user, a milestone corresponding to the advertisement presented to the user, a position of the advertisement in a sequence of advertisements presented to the user, amongst other factors.

The intensity of an advertisement can be agreed upon between the advertiser and the advertisement rendering system, wherein an advertisement may be assigned an intensity level from amongst a plurality of different intensity levels. A low intensity advertisement may be one that is not as intrusive or intense from the perspective of the user, while a high intensity advertisement may be very intense or highly targeted to the user with respect to a particular product. An example of a low intensity message may be “would you like to try restaurant X?” while an example of a high intensity advertisement may be “come to restaurant Y right now, these deals won't last!” The milestone corresponding to an advertisement can be a function of granularity of the advertisement. For instance, a first advertisement presented by an advertiser in an interactive advertising session may simply present a name of a retailer, while a second advertisement in the interactive advertising session may present a particular product that is available at such retailer, and a third advertisement in the interactive advertising session may indicate driving directions to such retailer. Presenting a name of a retailer may correspond to a first milestone, presenting a product that is available at the retailer may be a second milestone, and presenting driving directions to the user may be a third milestone. A fee charged to the advertiser can be based at least in part upon a milestone corresponding to the advertisements presented in the interactive advertising session.

As will be described in greater detail below, multiple advertisers may present advertisements in a single advertising session. Moreover, an advertisement in an advertising session for a first advertiser may be presented initially followed by an advertisement for a second advertiser, which may thereafter be followed by another advertisement for the first advertiser. Appropriate fees can be charged to each advertiser during these interactive advertising sessions, such that the first advertiser is not charged twice in an advertising session and that appropriate content is presented to the user for the purposes of advertising.

Other aspects will be appreciated upon reading and understanding the attached figures and description.

### BRIEF DESCRIPTION OF THE DRAWINGS

FIG. 1 is a functional block diagram of an exemplary system that facilitates charging advertisers for presenting advertisements during an interactive advertising session.

FIG. 2 is a functional block diagram of an exemplary system that facilitates selecting an advertisement for presentation to a user.

FIG. 3 illustrates an exemplary advertising session.

FIG. 4 is a flow diagram that illustrates an exemplary methodology for presenting a user with an interactive advertising session and charging advertisers that advertise in such interactive advertising session.

FIG. 5 is a flow diagram that illustrates an exemplary methodology for charging an advertiser for presenting an advertisement to a user during an interactive advertising session.

FIG. 6 is an exemplary computing system.

### DETAILED DESCRIPTION

Various technologies pertaining to interactive advertising sessions will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

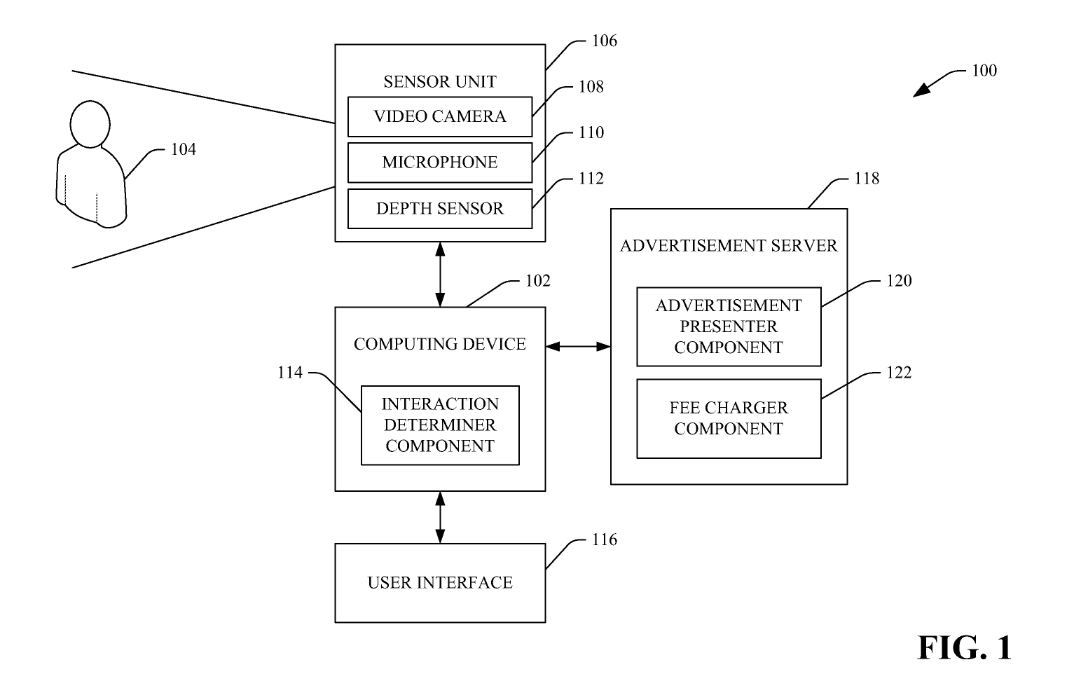

With reference to FIG. 1, an exemplary system 100 that facilitates rendering advertisements in an advanced interactive environment and charging advertisers for presentation of such advertisements to a user is illustrated. The system 100 comprises a computing device 102 that is utilized by a user 104 to perform a particular task. For example, the computing device 102 can be a gaming console, and the user 104 can be playing a video game through utilization of the computing device 102. In another exemplary embodiment, the computing device 102 may be or include a media player, and the user 104 can proffer voice commands to the computing device 102 to cause the computing device 102 to play selected media. In still yet another example, the computing device 102 may be a personal computing device such as a desktop computer, laptop computer, etc., and the user 104 may be employing the computing device 102 to perform one or more computing tasks such as search, word processing tasks, etc.

The system 100 further comprises a sensor unit 106 that is in electronic communication with the computing device 102. The sensor unit 106 is configured to monitor actions of the user 104 and provide such monitored actions to the computing device 102. For instance, the sensor unit 106 can comprise a video camera 108 that is directed toward the user 104 such that video images of the user 104 are captured and transmitted to the computing device 102. The video camera 108 can be a color video camera, or a black and white camera, and the video camera 108 can have a frame rate of at least 30 frames per second.

The sensor unit 106 can also comprise a microphone 110 that is configured to capture audio pertaining to a particular region, including audible outputs of the user 104. The sensor unit 106 also comprises a depth sensor 112 that can sense a distance of the user 104 from the sensor unit 106 and/or distance of other objects from the sensor unit 106. For example, the depth sensor 112 can be or include an infrared sensor that outputs infrared light that reflects off of the user 104, and the reflected light can be analyzed to ascertain depth of the user 104 and other objects in the range of the depth sensor 112. In another example, the depth sensor 112 can be or include a radar sensor that outputs radar signals to ascertain depth of the user 104 from the sensor unit 106. In yet another example, the sensor unit 106 can comprise multiple video cameras that are placed in a stereoscopic manner with respect to a typical location of the user 104, such that video images captured by these cameras can be analyzed to determine depth of the user 104 with respect to the sensor unit 106. Furthermore, while the video camera 108, the microphone 110 and the depth sensor 112 are shown as being included in the sensor unit 106, it is to be understood that each of these devices may have their own separate housing and can be independently coupled to the computing device 102. In another example, at least a portion of the sensor unit 106 may be included in the computing device 102. Thus, for instance, the computing device 102 may be a gaming console with a video camera, microphone and depth sensor included therein.

The computing device 102 comprises an interaction determiner component 114 that receives output from one or more modules in the sensor unit 106 and determines an interaction of the user 104 based at least in part upon the output from the sensor unit 106. For example, the interaction determiner component 114 can comprise speech recognition functionality that can recognize words spoken by the user 104 and captured by the microphone 110. Furthermore, in an example, the interaction determiner component 114 can be configured with gesture recognition functionality such that gestures of the individual 104 captured by the video camera 108 and/or the depth sensor 112 can be recognized by the interaction determiner component 114. Such gestures can include a wave of a hand, a pointing of a finger, the act of grabbing an item, etc. In still yet another example, the interaction determiner component 114 can infer emotions of the user 104 based at least in part upon audio data captured by the microphone 110 and/or video data captured by the video camera 108. For instance, video of the user 104 captured by the video camera 108 can indicate that the face of the user exhibits some particular emotion (a smile, a frown) and the interaction determiner component 114 can recognize such emotion based at least in part upon the content of the video. Furthermore, a tone in the voice of the user 104 can indicate a particular emotion of the user 104 and the interaction determiner component 114 can infer such emotion based at least in part upon the captured tone of the voice of the user 104.

The system 100 further comprises a user interface 116 that is in communication with the computing device 102. In an example, the user interface 116 may be a part of the computing device 102 or may be separate from the computing device 102. For instance, the user interface 116 may cause display data to be displayed on a display screen or may be the display screen itself. In another example, the user interface 116 may be a speaker that outputs audio signals to the user 104. In still yet another example, the user interface 116 may be a holographic production mechanism that can product holographic images for display to the user 104.

It can be ascertained that the computing device 102 in connection with the sensor unit 106 and the user interface 116 can enable rich interactions between the user 104 and data presented to the user. A combination of the computing device 102, the sensor unit 106 and the user interface 116 can be referred to as an advanced interactive platform, and through such platform the user 104 can richly interact with the computing device 102. Examples of interactions between the user 104 and the computing device 102 are provided herein for purposes of explanation. These examples are not intended to be limiting as to the scope of the hereto appended claims.

In a first example, the user 104 may initiate a web search by making an audible request that they would like to search for a particular item or topic. For instance, the user 104 may audibly output the phrase “I′d like to learn more about restaurant X”. The microphone 110 can capture this speech of the user and transmit the speech of the user 104 to the computing device 102. The interaction determiner component 114 can detect the intent of the user 104 by recognizing the speech of the user 104, and a search session can be initiated in an automated fashion by the computing device 102. Search results pertaining to restaurant X may then be presented to a user via the user interface 116. At this point, the user may wish to select a particular search result. The user 104 can point to a search result displayed via the user interface 116 and the interaction determiner component 114 can recognize the gesture of the user 104 in the video captured by the video camera 108. Responsive to this gesture, the computing device 102 can present updated information to the user 104 via the user interface 116.

In another example, the user 104 may be playing an interactive game through utilization of the sensor unit 106 of the computing device 102 and the user interface 116. The computing device 102 can present video data to the user 104 by way of the user interface 116 and the user 104 can react to that data presented on the user interface 116. These reactions can be verbal or nonverbal and can be in the form of words, gestures, facial expressions, etc. The interactions of the user 104 captured by the sensor unit 106 can be processed and recognized/inferred by the interaction determiner component 114 in the computing device 102, and data presented via the user interface 116 can be updated based at least in part upon these recognized interactions.

Given this advanced interactive environment wherein gestures, verbal cues, intent of the user and state of mind of the user can be recognized or inferred, advanced opportunities for advertising can be realized. Accordingly, the system 100 may comprise an advertisement server 118 that is configured to present an interactive advertising session to the user 104, wherein the interactive advertising session can be based at least in part upon recognized interactions of the user 104 with data presented to the user 104 via the user interface 116. The advertisement server 118 can comprise an advertisement presenter component 120 that presents an interactive advertising session to the user 104, wherein the interactive advertising session includes a plurality of advertisements presented to the user 104 in a sequence, and wherein an advertisement in the sequence is selected for presentment to the user based at least in part upon an interaction of the user 104 with respect to another advertisement presented to the user previously in the sequence. More particularly, the advertisement presenter component 120 can present an initial advertisement to the user 104 by way of the user interface 116 based at least in part upon some input from the user 104, wherein the input can be an audible input, a gesture, a recognized emotion, etc.

Furthermore this detected input can be based upon some contextual data such as time of day, day of week, weather conditions, etc. or an inferred emotion or state of mind of the user 104. Thus, a first advertisement in an interactive advertising session can be intelligently selected for presentment to the user via the user interface 116 through analysis of the data that is captured by way of the sensor unit 106 and analyzed by the interaction determiner component 114. Once the initial advertisement in the advertising sequence has been presented to the user 104, the user 104 can interact with such advertisement. For instance, the user 104 may generate an audible output pertaining to the advertisement presented via the user interface 116. The interaction determiner component 114 can detect an interaction of the user 104 based upon the audible output captured by the microphone 110, and the advertisement presenter component 120 can present a new advertisement based at least in part upon this interaction between the user 104 and the advertisement in the interactive advertising session. Accordingly, advertisements presented to the user 104 via the advertisement presenter component 120 can adapt based upon interactions with previous advertisements in the interactive advertising session.

The advertisement server 118 can additionally include a fee charger component 122 that can charge advertisers appropriate fees for presenting advertisements to the user 104 in an interactive advertising session. The fee charger component 122 can charge an advertiser (an owner of a particular advertisement) a particular fee based at least in part upon one or more factors. In a first example, the fee charger component 122 can charge an owner of an advertisement a fee based at least in part upon a position of the advertisement in a sequence of the interactive advertising session. For instance, an advertisement presented early in an interactive advertising session may be charged a higher fee than an advertisement presented later in the interactive advertising session. In another example, an advertiser may be charged a lower fee for an advertisement presented earlier in the interactive advertising session when compared to a fee charged to an advertisement presented later in the interactive advertising session. In yet another example, each advertisement presented by the advertisement presenter component 120 can be assigned a particular intensity level which can be agreed upon between the advertiser and the owner of the advertisement server 118. For instance, an advertisement that is very focused and has some sort of urgency about it can be assigned a relatively high intensity level while a more general advertisement that does not have a significant amount urgency about it may be assigned a relatively low intensity level. The fee charger component 122 can charge a greater fee for the advertisement with a high intensity level when compared to a fee charged to the advertisement with a low intensity level.

In another example, each advertisement may have a milestone or sub-milestone assigned thereto, and the fee charger component 122 can charge a fee with respect to an advertisement based at least in part upon the milestone or sub-milestone assigned to the advertisement. For instance, the user 104 may indicate that they are hungry. The interaction determiner component 114 can recognize the intent of the user and can pass this information to the advertisement server 118. The advertisement presenter component 120 may then provide an initial advertisement in an interactive advertising session to the user that promotes a particular restaurant. For instance, the advertisement server 118 can cause an audible output to be presented to the user via the user interface 116 such as “would you like to try restaurant X?” This advertisement can be associated with a first milestone. The user 104 may hear such advertisements and respond “where is this restaurant located?” This spoken phrase can be captured by the microphone 110 and passed to the computing device 102, wherein the interaction determiner component 114 can utilize speech recognition functionality to recognize the intent of the user 104. This intent can be passed back to the advertisement server 118, and the advertiser presenter component 120 can present an updated advertisement that says “restaurant X is located two miles away from you at the corner of street A and street B.” This advertisement, which provides a particular location of restaurant X, can be assigned a second milestone. A third milestone may be presentment of a menu of the restaurant to the user 104, and a fourth milestone may be presentment of specials at the restaurant X to the user 104. The fee charger component 122 can charge fees to the advertiser pertaining to these advertisements based at least in part upon the milestones assigned to the advertisements in the interactive advertising session.

In yet another example, the fee charger component 122 can charge fees to an advertiser based at least in part upon an amount or period of time that an advertisement is presented to the user 104 via the user interface 116. For instance, the advertisement server 118 can comprise a plurality of advertisement templates, wherein the templates may include some audible output that requires a particular amount of time to complete. The fee charger component 122 can charge advertisers based at least in part upon an amount of time that an advertisement is presented to the user 104 via the user interface 116. In still yet another example, the fee charger component 122 can charge an advertiser based at least in part upon an amount of screen space that is taken up by an advertiser presented by the advertisement presenter component 120. Thus, the larger the size of the advertisement, the greater the fee that can be charged to the corresponding advertiser.

Still further, the fee charger component 122 can charge a fee to an advertiser based at least in part upon priority corresponding to an advertisement. For instance, a first advertiser may be willing to pay more than a second advertiser for presenting an advertisement to the user initially when the interaction determiner component 114 infers that the user 104 is hungry (based at least in part upon actions or interactions captured by the sensor unit 106). In an example, the user 104 may hold her stomach and say “I am very hungry right now,” and the video camera 108 and the microphone 110 can capture such actions of the user 104. The interaction determiner component 114 can process the audio/video signals output from the sensor unit 106 and can infer that the user is hungry based at least in part upon such processing. This data can be provided to the advertisement server 118, and the advertisement presenter component 120 can select an advertisement of the first advertiser for presentment to the user 104. The first advertiser may be charged a particular fee by the fee charger component 122.

The user 104 can be presented with such advertisements and may say “No, I am not in the mood for that restaurant.” This interaction of the user 104 with respect to the initially presented advertisement can be captured by the sensor unit 106 and provided to the computing device 102. The interaction determiner component 114 can again process this audio/video signal and output the determined interaction of the user with the advertisement to the advertisement server 118. The advertisement presenter component 120 may then choose an advertisement corresponding to the second advertiser, wherein such advertisement has a lower priority than the first advertisement presented to the user 104. Thus, the fee charger component 122 can charge fees to advertisers based at least in part upon priorities assigned to advertisements.

From the above, it can be ascertained that during an interactive advertising session, advertisements from different advertisers can be presented based upon interactions between the user 104 and other advertisements presented to the user in the interactive advertising session. For instance, continuing with the example above, the user may indicate that she is hungry and an advertisement for a particular restaurant can be presented to the user 104. The user may respond to such advertisement by asking “what are the specials at restaurant X?” The advertisement presenter component 120, responsive to such interaction of the user 104, can output an advertisement that describes specials at restaurant X. At this point, the user 104 may ask “what are the specials at restaurant Y?” The advertisement presenter component 120 can then present an advertisement for restaurant Y that describes the available specials at restaurant Y to the user 104. The user 104 may review such specials and can ascertain that she is more interested in restaurant X. Accordingly, the user 104 can ask “where is the nearest location of restaurant X?” The advertisement presenter component 120 can receive such captured interaction between the user 104 and the presented advertisement and can present the user 104 with a new advertisement for restaurant X that shows the closest location of restaurant X to the user 104. The fee charger component 122 can take into consideration alterations of advertisers during a single interactive advertising session when charging fees to such advertisers. For example, the fee charger component 122 can store advertisements presented to the user 104 historically and can access these historical advertisements when determining which fees to charge for advertisements presented to the user 104 in an interactive advertising session.

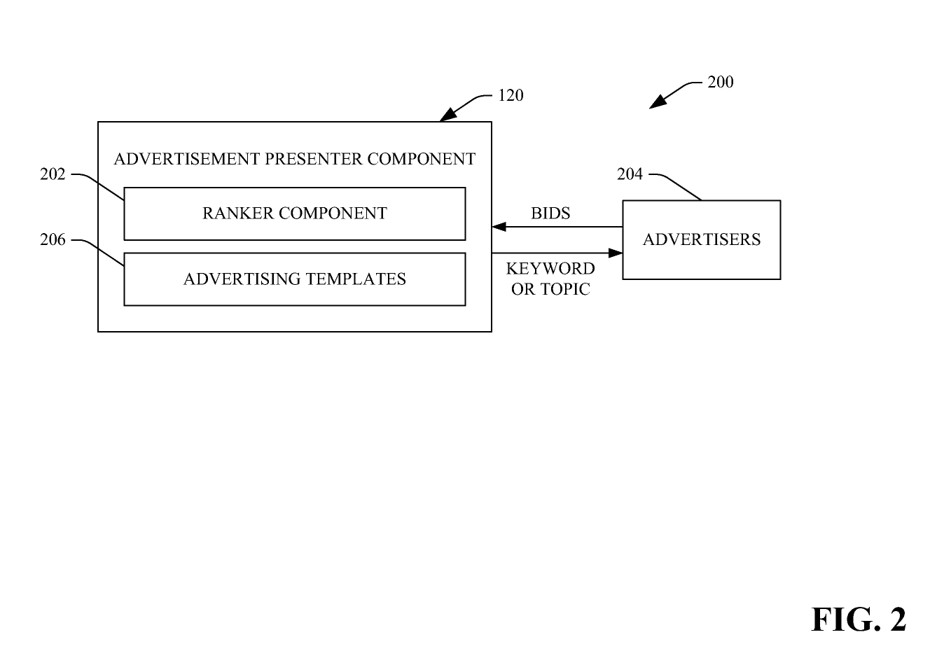

With reference now to FIG. 2, an exemplary system 200 that facilitates presenting interactive advertising sessions to a user is illustrated. The system 200 comprises the advertisement presenter component 120. The advertisement presenter component 120 can include a ranker component 202 that ranks advertisements for selection to present to a user in an interactive advertising session. Pursuant to an example, the data output by the interaction determiner component 114 (FIG. 1) can be received by the advertisement presenter component 120, wherein a detected interaction can be represented by an inferred topic or keyword based upon the detected interaction of the user. For instance, if the user indicates verbally that she is hungry, the interaction determiner component 114 can formulate a topic “restaurant”, and this topic can be provided to the advertisement presenter component 120. The advertisement presenter component 120 can present such topic to a plurality of advertisers 204, which can place bids on being an initial advertiser for this detected action/interaction of the user. For example, several advertisers 204 may wish to advertise to a user that indicates that she is hungry.

The ranker component 202 can receive these bids and can select an initial advertisement to display to the user in an interactive advertising session based at least in part upon the amount of the respective bids provided by the advertisers 204. For example, the ranker component 202 can perform a probabilistic calculation that takes into consideration known user interest, user history, user biases, etc. such that the likelihood that the user will be interested in the advertisement will be maximized and/or a profit of the search engine will be substantially maximized. If, upon being presented with the selected advertisement, the user indicates that they are not interested in the product or service that corresponds to the advertisement, then the advertisement presenter component 120 can select a next highest ranked advertisement based at least in part upon an amount bid by a corresponding advertiser.

Further, in an exemplary embodiment, the advertisement presenter component 120 can utilize the advertising templates 206 when presenting advertisements in an interactive advertising session to a user. These templates 206 may be audio templates, for example, such that blanks or open spaces in the audio can be filled by advertising data. An exemplary template may be “would you like to try ______?” wherein the blank can be filled in by a name of an advertiser. Many of these templates can be accessible to the advertisement presenter component 120, and the fee charger component 122 can charge an advertiser based at least in part upon the template utilized to present the advertisement to the user.

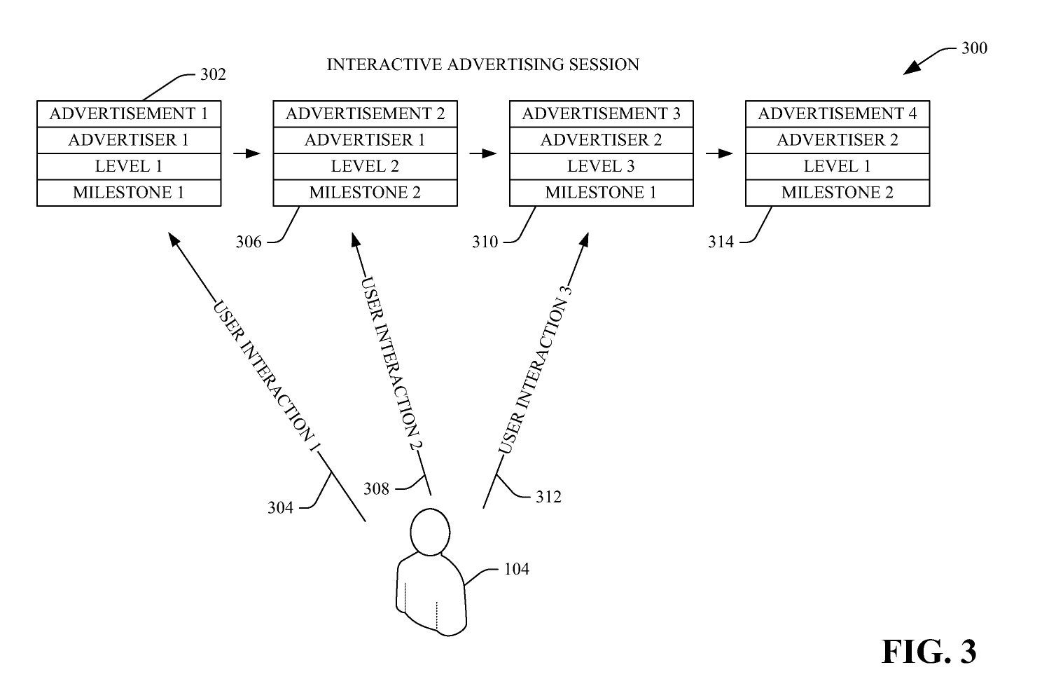

Now referring to FIG. 3, an exemplary interactive advertising session 300 is illustrated. In this example, the user is monitored and actions of the user are captured to infer a state of mind or intent of such user. In another example, the user 104 can indicate explicitly her state of mind or intent. Responsive to a user action, a first advertisement 302 from a first advertiser is presented to the user 104. The advertisement 302 may have a particular intensity level associated therewith and/or milestone data associated therewith, and a fee can be charged to the first advertiser based at least in part upon the intensity level and/or the milestone corresponding to the first advertisement 302.

The user 104 can consume the first advertisement 302 and can undertake a first user interaction 304 with respect to the first advertisement 302. This first user interaction 304 can cause a second advertisement 306 to be presented to the user 104 in the interactive advertising session 300, wherein the second advertisement 306 is presented based at least in part upon the first user interaction 304 and/or the previous advertisement 302 presented to the user 104. In the example shown in FIG. 3, the second advertisement 306 can be owned by the same first advertiser but can have an upgraded intensity level and milestone level. Thus, for instance, the second advertisement 306 may be more intense when compared to the first advertisement 302. Furthermore, the second advertisement 306 corresponds to a different milestone than the first advertisement 302, and thus a fee charged to the second advertisement 306 may be different than a fee charged to the first advertisement 302.

In the exemplary interactive advertising session 300, the user 104 may then change course and provide a second user interaction 308 that indicates that the user 104 is not interested in advertisements 302 or 306 at this point in time. For example, the user 104 may make a statement such as “please show me an alternative product from another company.” Subsequent and responsive to the second user interaction 308, a third advertisement 310 can be presented to the user 104, wherein the third advertisement 310 is for a second advertiser at a third intensity level and a first milestone level. Accordingly, the second advertiser can be charged for the third advertisement 310 based at least in part upon the third intensity level and the first milestone.

The user 104 may then have a third user interaction 312 responsive to being presented with the third advertisement 310, which can cause a fourth advertisement 314 to be presented to the user 104. The fourth advertisement 314 can be owned by the second advertiser and may correspond to a second milestone. Again, the second advertiser can be charged for presenting the fourth advertisement 314 in the interactive advertising session to the user 104 based at least in part upon the intensity level and the milestone that corresponds to the fourth advertisement 314. From this example, it can be ascertained that the interactive advertising session 300 can include multiple advertisements that are presented to the user 104 in a sequence, wherein presentation of such advertisements depends on captured user interactions with respect to advertisements and previous advertisements that are presented in the interactive advertising session 300. Furthermore, advertisers can be charged based at least in part upon a priority corresponding to a certain advertisement, intensity level corresponding to an advertisement, milestone corresponding to an advertisement, etc.

In an example, at least one advertisement in the interactive advertising session 300 can be presented to the user 104 by way of an avatar. For instance, the user 104 may be playing a game on a gaming console, and during game play an avatar can appear that presents an advertisement to the user. In another example, the user can pause the game, and upon pausing the game the avatar can present the advertisement to the user. In yet another exemplary embodiment, a user can perform a search, and an avatar can be presented to the user that presents an advertisement to the user. The user may then interact with such avatar, and the avatar can present advertisements to the user in the interactive advertising session based at least in part upon captured interactions between the user 104 and the avatar. In a related example, two Advertisers (advertiser 1 and advertiser 2) may wish to advertise to a user. Each advertiser may have an interactive advertising session they would like to present to the user 104; thus, advertiser 1 may wish to present interactive advertising session 1 (IA1) to the user 104 while advertiser 2 may wish to present interactive advertising session 2 (IA2) to the user. Still further, IA1 may be divided into multiple advertisements (IA11, IAl2, IA13, etc.) and IA2 may be divided into multiple advertisements (IA21, IA22, IA23, etc.). Each of the advertisements may have intensity values and milestone values assigned thereto, which defines the cost of rendering.

Based upon some user action, an advertisement rendering opportunity can be identified, and IA11 can be initially presented to the user 104. The user may provide some form of negative feedback, and accordingly IA21 can be presented to the user 104. At this point in time, the user 104 may request for data pertaining to IA1, and accordingly IAl2 can be presented to the user. Accordingly, fees charged to advertiser 1 for presenting advertisements in IA1 can account for the fact that IA1 was not rendered continually, but had some gaps. However, the amount charged to advertiser 1 can be a sum of charges of all the advertisements presented in IA1.

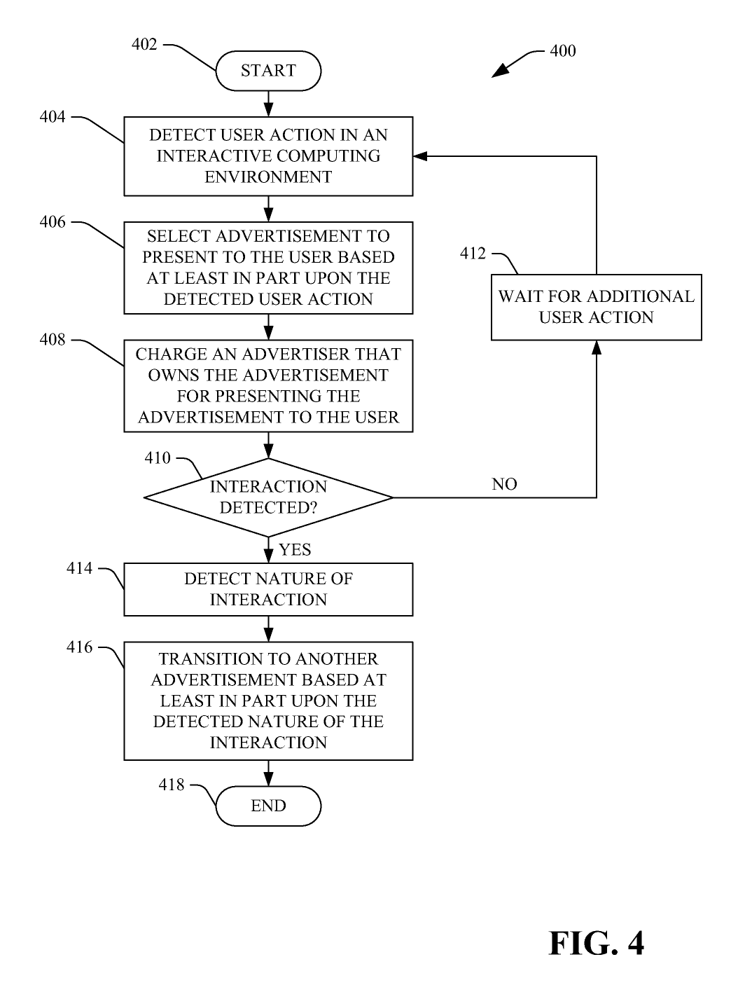

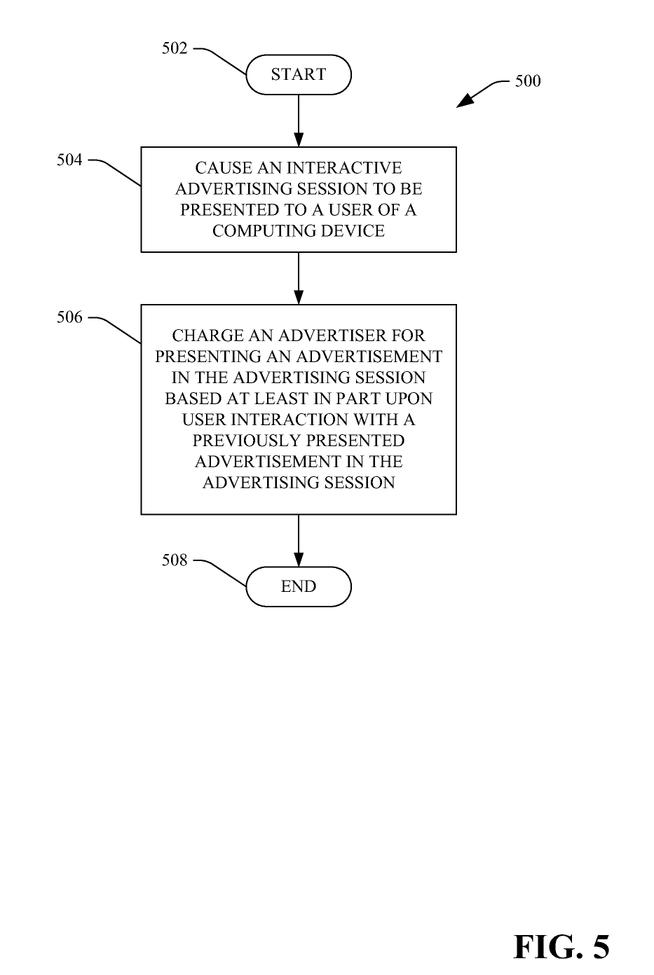

With reference now to FIGS. 4-5, various exemplary methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be a non-transitory medium, such as memory, hard drive, CD, DVD, flash drive, or the like.

Referring now to FIG. 4, an exemplary methodology 400 that facilitates charging an advertiser for displaying an advertisement in an interactive advertising session is illustrated. The methodology 400 begins at 402, and at 404 a user action is detected in an advanced interactive computing environment. For example, the user action may be a gesture captured by way of a video camera, a spoken word captured by way of a microphone, an emotion captured by way of a video camera and/or microphone, etc. Thus, an interactive computing environment is one in which the user is not constrained through the use of a mouse and a keyboard to interact with a computer but can instead interact in a manner which is consistent with human interaction, such as through gestures, spoken words, facial expressions, tones in speech, etc.

At 406, an advertisement is selected to present to the user in an interactive advertising session based at least in part upon the detected user action. For example, the advertisement can be reflective of a current informational interest of the user, a current desire of the user, etc.

At 408, an advertiser that owns the advertisement selected in 406 is charged for presenting such advertisement to the user. For example, the advertiser can be charged a relatively high fee for having an advertisement presented first upon detection of the user action (rather than another advertisement from an advertisement competing in a same domain as the advertiser). At 410, a determination is made regarding whether a subsequent interaction of the user is detected with respect to the presented advertisement. If there is no detected interaction, then the methodology 400 proceeds to 412, where additional action/input from the user is awaited (e.g., another gesture, another emotion exhibited by the user, . . . ). If at 410 a subsequent interaction is detected, then at 414 a nature of such interaction is detected. That is, whether the interaction is positive with respect to the presented advertisement or negative with respect to the presented advertisement can be detected.

At 416, a transition is made to another advertisement based at least in part upon the detected nature of the interaction with respect to the presented advertisement. For example, a more granular advertisement can be shown, an advertisement for a different product can be shown, a location of a particular product can be shown, etc. The methodology 400 completes at 418.

Now referring to FIG. 5, an exemplary methodology 500 that facilitates charging an advertiser for presenting an advertisement during an interactive advertising session is illustrated. The methodology 500 begins at 502, and at 504 an interactive advertising session is caused to be presented to a user of a computing device. For instance, the interactive advertising session may include multiple different advertisements that are presented to the user in a particular sequence, wherein the advertisements in the multiple different advertisements are selected for presentation to the user based at least in part upon interactions of the user with respect to previously displayed advertisements in the sequence of advertisements in the interactive advertising session.

At 506, at least one owner of at least one advertisement presented in the interactive advertising session is charged based at least in part upon an interaction of the user with respect to an advertisement that was presented earlier in the sequence when compared to the at least one advertisement. The methodology 500 completes at 508.

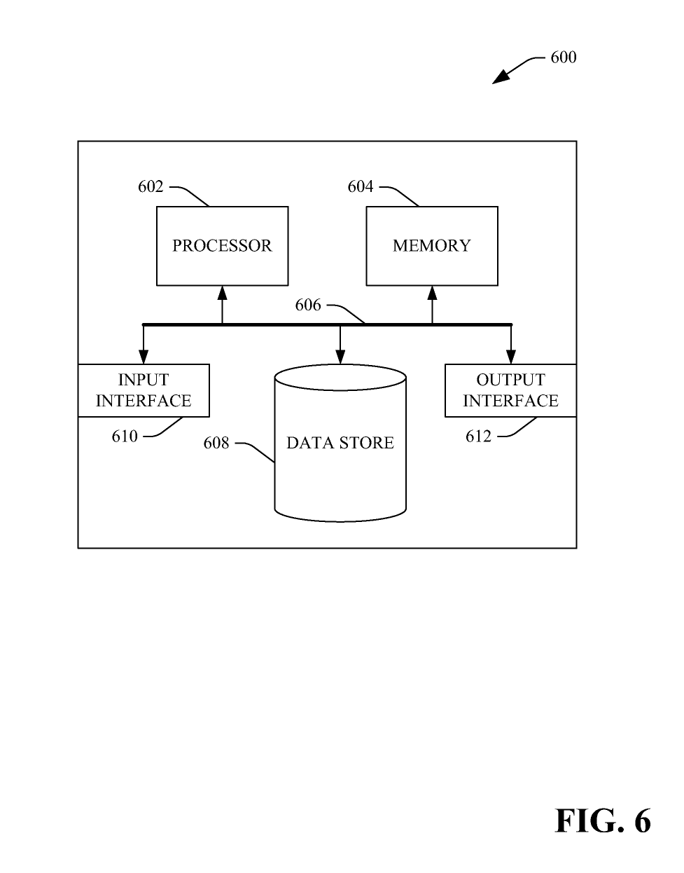

Now referring to FIG. 6, a high-level illustration of an exemplary computing device 600 that can be used in accordance with the systems and methodologies disclosed herein is illustrated. For instance, the computing device 600 may be used in a system that supports providing an interactive advertising session to a user. In another example, at least a portion of the computing device 600 may be used in a system that supports charging advertisements for advertisements presented to a user during an interactive advertising session. The computing device 600 includes at least one processor 602 that executes instructions that are stored in a memory 604. The memory 604 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 602 may access the memory 604 by way of a system bus 606. In addition to storing executable instructions, the memory 604 may also store advertisements, advertisers, levels associated with advertisements, etc.

The computing device 600 additionally includes a data store 608 that is accessible by the processor 602 by way of the system bus 606. The data store 608 may be or include any suitable computer-readable storage, including a hard disk, memory, etc. The data store 608 may include executable instructions, advertisements, etc. The computing device 600 also includes an input interface 610 that allows external devices to communicate with the computing device 600. For instance, the input interface 610 may be used to receive instructions from an external computer device, from a user, etc. The computing device 600 also includes an output interface 612 that interfaces the computing device 600 with one or more external devices. For example, the computing device 600 may display text, images, etc. by way of the output interface 612.

Additionally, while illustrated as a single system, it is to be understood that the computing device 600 may be a distributed system. Thus, for instance, several devices may be in communication by way of a network connection and may collectively perform tasks described as being performed by the computing device 600.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices. Furthermore, a component or system may refer to a portion of memory and/or a series of transistors.

It is noted that several examples have been provided for purposes of explanation. These examples are not to be construed as limiting the hereto-appended claims. Additionally, it may be recognized that the examples provided herein may be permutated while still falling under the scope of the claims.

1. A method executed by a computer processor, the method comprising:
causing an interactive advertising session to be presented to a user of a computing device, wherein the interactive advertising session comprises multiple different advertisements presented to the user in a sequence, and wherein advertisements in the multiple different advertisements are selected for presentation to the user based at least in part upon interactions of the user with respect to previously displayed advertisements in the sequence; and
charging at least one owner of at least one advertisement presented in the interactive advertising session based at least in part upon an interaction of the user with respect to an advertisement that was presented earlier in the sequence to the user when compared to the at least one advertisement.

2. The method of claim 1, wherein the computing device is a gaming console.

3. The method of claim 1, wherein the interactions of the user are captured by way of at least one of a video camera or a microphone.

4. The method of claim 1, wherein the at least one advertisement in the interactive advertising session is presented to the user by way of an avatar.

5. The method of claim 1, wherein advertisements in the advertising session are assigned a level of intensity, and wherein the at least one owner of the at least one advertisement is charged a fee for presenting the at least one advertisement based at least in part upon the level of intensity assigned to the at least one advertisement.

6. The method of claim 1, wherein advertisements in the interactive advertising session have different owners, and wherein transition to advertisements with different owners is based at least in part upon a detected interaction of the user.

7. The method of claim 1, wherein the multiple different advertisements are owned by a common owner, and wherein fees charged to the common owner for the multiple different advertisements are based at least in part upon a respective positions of the multiple different advertisements in the sequence.

8. The method of claim 1, further comprising:
presenting the at least one advertisement for a particular period of time to the user; and
charging the at least one owner of the at least one advertisement based at least in part upon the particular period of time that the at least one advertisement is presented to the user.

9. The method of claim 8, wherein the particular period of time is calculated based at least in part upon an advertising template utilized in connection with presenting the at least one advertisement to the user.

10. The method of claim 8, wherein the particular period of time is limited by a user interaction.

11. The method of claim 1, wherein a first advertisement in the advertising session is presented to the user based at least in part upon contextual data corresponding to the user, wherein the contextual data comprises at least one of time of day, day of week, or current weather conditions.

12. A system comprising:
a processor; and
a memory that comprises a plurality of components that are executed by the processor, the plurality of components comprising:
an advertisement presenter component that presents an interactive advertising session to a user, wherein the interactive advertising session comprises a plurality of advertisements presented to the user in a sequence, and wherein an advertisement in the sequence is selected for presentment to the user based at least in part upon an interaction of the user with respect to another advertisement presented to the user previously in the sequence; and
a fee charger component that charges an owner of the advertisement a fee based at least in part upon a position of the advertisement in the sequence.

13. The system of claim 12, wherein each advertisement in the plurality of advertisements is assigned an intensity level, and wherein the fee charger component charges the owner of the advertisement a fee based at least in part upon the intensity level assigned to the advertisement.

14. The system of claim 12, wherein each advertisement in the plurality of advertisements is assigned a milestone level, and wherein the fee charger component charges the owner of the advertisement a fee based at least in part upon the milestone level assigned to the advertisement.

15. The system of claim 12, the plurality of components further comprising:
an interaction determiner component that recognizes interactions of the user with respect to advertisements in the interactive advertising session based at least in part upon data from a sensor unit, wherein the sensor unit comprises a video camera and a microphone.

16. The system of claim 12, wherein a server comprises the advertisement presenter component and the fee charger component, and wherein the advertisement component receives the interaction from a gaming console of the user.

17. The system of claim 16, wherein the interactive advertising session is presented to the user in a gaming environment.

18. The system of claim 12, wherein the fee charger component charges the owner of the advertisement a fee based at least in part upon an amount of time that the advertisement is presented to the user.

19. The system of claim 18, wherein the amount of time is limited by a captured user interaction with respect to the advertisement.

20. A computer-readable data storage device comprising instructions that, when executed by a processor, cause the processor to perform acts comprising:
presenting an interactive advertising session to a user of a gaming console, wherein the interactive advertising session comprises a plurality of advertisements presented to the user in a sequence, wherein a first advertisement in the sequence is presented to the user based at least in part upon a recognized user action, and wherein a second advertisement in the sequence is presented to the user based at least in part upon a user interaction with respect to the first advertisement, wherein the user interaction is detected by way of analysis of audio/video data captured by way of a video camera and microphone; and
charging a fee to an owner of the second advertisement based at least in part upon the user interaction with respect to the first advertisement.
